(19) United States
(12) Patent Application Publication
(10) Pub. No.: US 2005/0060067 A1
(43) Pub. Date: Mar. 17, 2005

(54) Apparatus for performance control of remote control operation service, and system and method for provision of same

(75) Inventor: Junichi Nishida, Aichi-ken (JP)

Correspondence Address: Finnegan, Henderson, Farabow,;Garrett & Dunner, L.L.P., 1300 I Street, N.W., Washington, DC, 20005-3315, US

(73) Assignee: Toyota Jidosha Kabushiki Kaisha

(21) Appl. No.: 10/938,944

(22) Filed: Sep. 13, 2004

(30) Foreign Application Priority Data
Sep. 12, 2003 (JP) 2003-320900

(51) Int. Cl. G06F 17/00

(52) U.S. Cl. 701/2; 701/36

(57) ABSTRACT

If a control portion determines, upon receipt of the service request information, that a battery does not have enough remaining voltage to start an engine, the control portion notifies the driver by sending a service rejection notification via the center. However, if the battery has sufficient remaining charge, when the operation start time is reached, the control portion performs the remote control operation service by causing the light to flash. Further, if the control portion detects that the voltage of the battery has reduced during the performance of the remote control operation service to a level at which starting the engine will be difficult, the control portion compulsorily terminates the remote control operation service that is being performed in order to make sure that the engine can be started.

### INCORPORATION BY REFERENCE

The disclosure of Japanese Patent Application No. 2003-320900 filed on Sep. 12, 2003 including the specification, drawings and abstract is incorporated herein by reference in its entirety.

### BACKGROUND OF THE INVENTION

1. Field of the Invention

The invention relates to a remote control operation service system which can supply a telematics service for a vehicle, and more particularly, which can favorably supply a remote control operation service. Further, the invention also relates to an apparatus and a method that can be favorably used with this system.

2. Description of the Related Art

Telematics is a word that combines the words communication and information science (informatics), and is often used when referring to next-generation information provision services for automobiles. As one service form in which telematics is realized, remote control operation services have been proposed that allow a vehicle to be operated from a remote location. For example, it is possible to operate an on-board vehicle device or instrument from a remote location by wirelessly transmitting commands to a vehicle provided with a telematics function. For example, a door may be unlocked, a light flashed, or a horn sounded, even if an ignition switch of the vehicle is not turned on.

Specific examples in which such remote control operation services are applied have been disclosed in Japanese Patent Laid-Open Publication No. 10-266934, Japanese Patent Laid-Open Publication No. 2003-158822, Japanese Patent Laid-Open Publication No. 11-250379, and Japanese Patent Laid-Open Publication No. 2003-070175.

For example, if a driver has become confused about the location of his/her vehicle within a large parking lot, the driver can ring up a call center of a remote control operation service of which he is a registered member. Then, the driver can request the operator at the call center to, for example, make the vehicle's lights flash for a continuous period from a predetermined start time. Next, the operator transmits a service request to the vehicle in accordance with the request of the driver. This service request is received by a telematics terminal unit that is mounted in the vehicle of the driver who is utilizing the service. Then, when the stipulated start time is reached, the telematics terminal unit causes the lights to flash for the predetermined time in accordance with the wirelessly received service request. Accordingly, the driver is able to find his vehicle in the large parking lot by searching for a vehicle whose lights are flashing.

However, with the telematics terminal unit described above, when an on-board vehicle device (in this case, the lights) is operated for a predetermined time in line with the service request for remote control operation, electric power of a battery is used up. However, at this time, the ignition switch remains turned off while the service is being performed, namely, while the on-board vehicle device is operated. Thus, when the above described remote control operation service is used, if the driver sets the service continuation time (namely, the time for which the lights flash) to be long, a large amount of electric power of an on-board battery is used up. As a result, it is possible that the battery voltage will be insufficient for starting the engine. In other words, given that the driver has no way of knowing the remaining charge of the on-board battery, and the like, the driver will find it is difficult to set an adequately long period for the service continuation time since his/her will be concerned to avoid the occurrence of secondary problems, such as being unable to start the engine.

### SUMMARY OF THE INVENTION

It is an object of the invention to provide a remote control operation service performance control apparatus, a vehicle remote control operation service system, and a vehicle remote control operation service provision method that can favorably provide a remote control operation service.

According to a first aspect of the invention, a remote control operation service performance apparatus includes a wireless communication unit that exchanges information with a portable user terminal unit, and a control unit that performs operation control of an on-board vehicle device in accordance with service request information that is received from the wireless communication unit. The control unit determines, based on a state of a storage battery unit that supplies electric power to the on-board vehicle device, whether to perform the operation control of the on-board vehicle device in accordance with a service request from the portable user terminal unit.

According to this configuration of the invention, a state of a power supply unit (namely, the storage battery unit) is checked when provision of the remote control operation service is started. Accordingly, it is possible to prevent secondary problems from occurring in advance, such as when a driver returns to his vehicle having used the remote control operation service and finds that the engine is unable to start. Moreover, the state of the power supply unit (the storage battery unit) is not only checked when the remote control operation service is started, but also during its provision. Thus, it is possible to reliably prevent problems like that described above from occurring.

The first aspect may be configured such that, the service request information includes an operation control command that causes the on-board vehicle device to operate.

The first aspect may be configured such that, when the state of the storage battery unit is a predetermined state that indicates a predetermined service rejection condition, the control unit determines that the state of the storage battery unit makes it difficult to perform the operation control of the on-board vehicle device in accordance with the service request from the portable user terminal unit. Accordingly, the control unit transmits a service rejection notification to the portable user terminal unit in response to the service request.

Moreover, the first aspect may be configured such that, when the control unit determines that the state of the storage battery unit during performance of a remote control operation service makes it difficult to perform the operation control of the on-board vehicle device, the control unit compulsorily terminates the remote control operation service that is being performed.

The first aspect may be configured such that, the service rejection condition includes a condition that voltage value of the storage battery unit is equal to or lower than predetermined voltage value.

According to a second aspect of the invention, a vehicle remote control operation service system includes: a center that uses wireless communication to request that the vehicle perform a remote control operation service in accordance with a service request from a portable user terminal unit; and a remote control operation service performance control apparatus which is mounted in the vehicle and which includes a wireless communication unit that wirelessly communicates with the center. The center is at a location that is remote from the vehicle. This remote control operation service performance control apparatus provides the remote control operation service in accordance with service request information that is received from the center. Further, a control unit is mounted in the remote control operation service performance control apparatus and performs operation control of an on-board vehicle device in accordance with the service request information received from the center. Moreover, a service performance control unit is provided that determines, based on a state of a storage battery unit that supplies electric power to the on-board vehicle device, whether the control unit should perform the operation control of the on-board vehicle device in line with the service request from the portable user terminal unit.

In addition, the second aspect may be configured such that the service performance control unit is provided at the center and determines whether the control unit should perform the operation control of the on-board vehicle device based on information indicating the state of the storage battery unit. This information is sent via the wireless communication unit from the control unit.

The second aspect may be configured such that, the service request information includes an operation control command that causes the on-board vehicle device to operate.

The second aspect and its various forms may be configured such that, when the state of the storage battery unit is a predetermined state that indicates a predetermined service rejection condition, the service performance control unit determines that the state of the storage battery unit makes it difficult to perform the operation control of the on-board vehicle device in accordance with the service request from the portable user terminal unit. Accordingly, the service performance control unit transmits a service rejection notification to the portable user terminal unit in response to the service request.

The second aspect may be configured such that, the service rejection condition includes a condition that voltage value of the storage battery unit is equal to or lower than predetermined voltage value.

Moreover, the second aspect and its various forms may be configured such that when the state of the storage battery unit becomes a predetermined state that indicates a predetermined service rejection condition during performance of the remote control operation service, the service performance control unit determines that the state of the storage battery unit makes it difficult to perform the operation control of the on-board vehicle device in line with the service request from the portable user terminal unit. Accordingly, the service performance control unit compulsorily terminates the remote control operation service that is being performed by stopping the operation control of the on-board vehicle device performed by the control unit.

The second aspect may be configured such that, the service rejection condition includes a condition that voltage value of the storage battery unit is equal to or lower than predetermined voltage value.

According to a third aspect of the invention, a remote control operation service provision method provides a remote control operation service for a vehicle having a wireless communication unit. This remote control operation service is provided by performing operation control of an on-board vehicle device in accordance with a service request from a portable user terminal unit. The method includes a step of detecting a state of a storage battery unit that supplies electric power to the on-board vehicle device. This detecting step is performed when the wireless communication unit receives the service request from the portable user terminal unit. Further, the method also includes a step of determining whether to perform the operation control of the on-board vehicle device in accordance with the service request from the portable user terminal unit based on the detected state of the storage battery unit.

The third aspect may be configured such that, the service request information includes an operation control command that causes the on-board vehicle device to operate.

The method of the third aspect may further include a step of notifying the portable user terminal unit that provision of the remote control operation service is rejected when the determining step determines that it is difficult to perform the operation control of the on-board vehicle device based on the fact that the state of the storage battery unit is a predetermined state that indicates a predetermined service rejection condition.

The third aspect may be configured such that, the service rejection condition includes a condition that voltage value of the storage battery unit is equal to or lower than predetermined voltage value.

The method of the third aspect may further include a during-service detection step that periodically detects the state of the storage battery unit during provision of the remote control operation service. Moreover, the method may also include a termination step that, when the during-service detection step detects that the state of the storage battery unit is a predetermined state that indicates a predetermined service rejection condition, compulsorily terminates the remote control operation service that is being provided.

The third aspect may be configured such that, the service rejection condition includes a condition that voltage value of the storage battery unit is equal to or lower than predetermined voltage value.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 shows a configuration of an embodiment of a remote control operation service system according to the invention;

FIG. 2 is a flow chart showing an operation of a telematics terminal unit of the embodiment;

FIG. 3 shows an example of an operation control for a light that is performed by a control portion of the embodiment of the invention; and

### DETAILED DESCRIPTION OF THE PREFERRED EMBODIMENTS

Hereinafter, a preferred embodiment of the invention will be described with reference to the drawings.

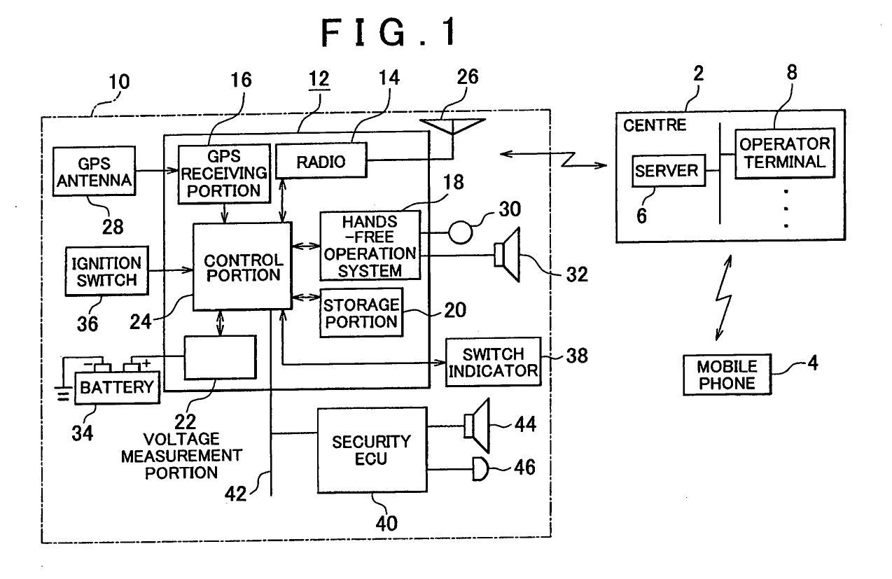

FIG. 1 shows a configuration of an embodiment of a remote control operation service system according to the invention. FIG. 1 shows a center 2 that provides a remote control operation service; a mobile phone 4 that is carried by a driver who is registered user of the remote control operation service; and a vehicle 10 that is owned by the driver. The remote control operation service that is performed in this embodiment is, in outline, as follow: (a) An operator who is stationed at the center 2 responds to a call made by the driver to the center 2; (b) Remote control operation of the vehicle 10 owned by the driver is performed in accordance with a request made by the driver. The details of the request made by the driver may be, for example, a request to perform operation control of an on-board vehicle device, such as causing a light to flash for a continuous period from a determined starting time.

The remote control operation service is provided by controlling an operation of the on-board vehicle device in accordance with the request from the driver, as described above. However, in order to provide this surface, the center 2 includes: a unit for performing wireless communication with both the mobile phone 4 and a telematics terminal unit 12 mounted in the vehicle 10; a server 6 which is connected to a data base (not shown) that stores information about registered members and registered vehicles, and which can realize a remote control operation service function; and a plurality of operator terminals 8 that are connected to the server 6 via a network.

The telematics terminal unit 12 mounted in the vehicle 10 is connected to various types of on-board vehicle device such as an electronic control system. The telematics terminal unit 12 has a radio 14, a GPS receiving portion 16, a hands-free operation system 18, a storage portion 20, a voltage measurement portion 22, and a control portion 24. The telematics terminal unit 12 functions as a remote control operation service performance control apparatus that provides the remote control operation service in accordance with the service request information that is received from the center 2. The radio 14 performs wireless communication with the center 2 via a radio antenna 26. The GPS receiving portion 16 receives position information about the vehicle 10 via a GPS antenna 28. The hands-free operation system 18 is connected to a microphone 30 and a speaker 32, and can be used by the driver to speak to the center 2 while he is driving the vehicle 10.

The voltage measurement portion 22 measures, in the case of the embodiment described herein, a battery voltage that is taken to indicate a state of a battery 34 that supplies electric power to the various types of on-board vehicle device. Note that, in this case, the battery 34 is mounted in the vehicle in a normal manner. Note that, more specifically, the voltage measurement portion 22 is a portion that measures a voltage of an electric power supply that acts as an electric power supply source for when an engine, not shown, is being started. The control portion 24 is a control processing unit that is a key portion for realizing a telematics function of the vehicle 10. This control portion 24 performs the remote control operation service by performing operation control of the various types of on-board vehicle device in accordance with the service request information transmitted from the center 2. In order to achieve this, the control portion 24 (i) monitors respective states of and (ii) performs operation control for the various types of on-board vehicle device that are included in the telematics terminal unit 12, namely, basic instruments and devices of the vehicle 10 such as an ignition switch 36, a switch indicator 38, and the like.

Moreover, the control portion 24 is connected via a Controller Area Network (CAN) 42 to a security Electronic Control Unit (ECU) 40 that is a control unit for a vehicle electronic control system. Thus, in addition to performing direct operation control of the various on-board vehicle devices, the control portion 24 performs indirect operation control of on-board vehicle devices like a horn 44 and a light 46 via the security ECU 40.

Next, an explanation will be given about the operation of the embodiment with the above described configuration when the remote control operation service is provided. The remote control operation service of the embodiment is realized, as described above, by performing remote control of the vehicle 10 owned by the driver in accordance with the request of the driver, namely, by controlling the light 46 to flash, or the horn 44 to sound. Note that, the basic scenario of the description below is: (1) a driver has parked his vehicle in an extremely large parking lot at, for example, a suburban home center or amusement park; (2) the driver is using the remote control operation service in order to locate his vehicle within the parking lot. Further, it is also assumed that information concerning the driver is registered at the center 2 since the driver is a registered member of the remote control operation service. The registered information includes the driver's registration ID, personal information such as his name and address, the registration number of the vehicle owned by the driver, and vehicle information like the vehicle identification number. By utilizing the registered information, the center 2 is able to confirm the identity of the user and identify who the wireless communication partner is, namely, which telematics terminal unit 12 is being communicated with.

First, the driver, who cannot find his vehicle in the parking lot, makes a call to the center 2 at which his information is registered. For the description of this embodiment, it is assumed that the driver uses the mobile phone 4 to make this call. However, it goes without saying that a public telephone may be used. An operator who is stationed at the center 2 confirms a user ID through input of a password, or the like. Then, the operator sets an on-board vehicle device that is to be activated, operation details therefor, a service start time, and a service continuation time. In this example, the operation details for the on-board vehicle device are, for example, causing the horn 44 to sound, or making the light 46 flash. Also note that, in the case that the light 46 is caused to flash, the service start time for is set as the time at which the light 46 starts to flash; and the service continuation time is set as the length of time for which the light 46 flashes (e.g., 10 minutes).

The server 6 then transmits service request information (that includes the on-board vehicle device, the operation details, and the service start time and service continuation time that have been set by the operator) to the vehicle 10 via a wireless communication unit, not shown. More specifically, (a) an operation control command, namely, “sound the horn 44” or “flash the light 46”, and (b) parameter values that indicate the service start time and the service continuation time are transmitted. Accordingly, operation instructions are provided to the telematics terminal unit 12 mounted in the vehicle.

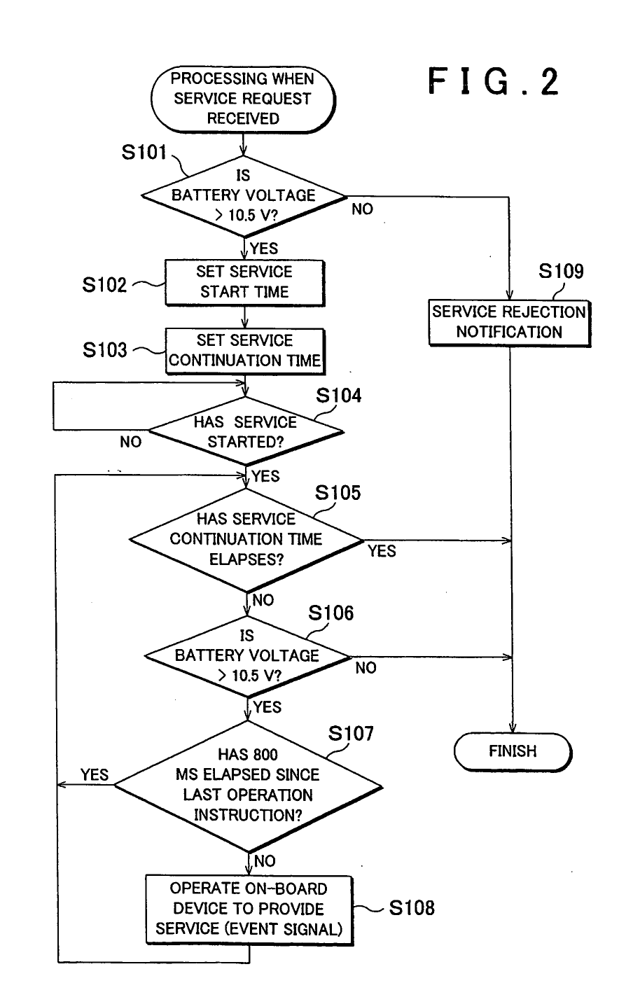

When the service request information is received from the center 2 via the radio 14, the telematics terminal unit 12 performs the operation described below. This operation of the telematics terminal unit 12 will be explained while reference to the flow chart shown in FIG. 2.

When the control portion 24 receives the service request information sent by the center 2, it determines whether or not the battery voltage of the battery 34 measured by the voltage measurement portion 22 is 10.5 V or more (Step S101). Note that, 10.5 Volts is the minimum battery capacity necessary for starting the engine. In this example, when the battery voltage of the battery 34 is equal to or above 10.5, it is determined that the remote control operation service can be provided in accordance with the request of the driver. Thus, the control portion 24 sets time parameters for the service start time and the service continuation time that are included in the service request information (Steps S102, S103). Then, the routine waits until the service start time (Step S104).

On the other hand, when the battery voltage of the battery 34 is less than 10.5 V, the battery 34 is getting low. If electric power is consumed (by, for example, causing the light 46 to flash) when the battery 34 is in this state, there is a possibility that it will become impossible to start the engine. Thus, in this case, the control portion 24 determines that the remote control operation service cannot be provided in accordance with the request of the driver, and transmits a service rejection notification to the center 2 (step S109). When the server 6 of the center 2 receives the service rejection notification, the specific details of the notification are displayed on the operator terminal 8. The operator then reads the notification, and explains to the driver that it is not possible to provide the remote control operation service since the battery 34 of the vehicle 10 owned by the driver is low. Note that, at this time, the driver and the operator are still connected by the mobile phone 4. Thus, the operator is able to respond in his own voice to the driver. Of course, the notification method used to inform the driver is not limited to this. A function of the mobile phone 4 may be effectively utilized, or alternatively, a message stating that the use of the remote control operation service has been rejected may be displayed on the mobile phone 4.

According to this embodiment, the state of the battery is checked prior to provision of the remote control operation service in the above described manner. Accordingly, it is possible to prevent secondary problems from occurring in advance, such as when a driver returns to his vehicle having used the remote control operation service and finds that the engine is unable to start.

Note that, in the above explanation, when the battery voltage of the battery 34 is equal to or above 10.5 V, a confirmation notification indicating acceptance of the remote control operation service is not transmitted in the same manner as the service rejection notification. This is because transmission of such a message will reduce the battery voltage. Accordingly, rather than sending a confirmation message indicating acceptance of the remote control operation service, the minimization of electric power consumption is prioritized by not sending a confirmation notification. However, for example, the determination criterion for determining whether the remote control operation service is accepted may be changed to a value larger than 10.5 V If this is done, the specifications may be changed such that a confirmation message indicating acceptance of the remote control operation service is transmitted to the driver via the center 2. Further, in this case, the control portion 24 may transmit the vehicle position information obtained by the GPS receiving portion 16 along with the confirmation notification. Accordingly, the center 2 is able to inform the driver of the rough location of his vehicle within the parking lot, which is obviously helpful to the driver.

In step S104, when the set service start time is reached, the control portion 24 repeatedly executes the following processing in accordance with the operation control command included within the service request information (step S105). This process continues until the set service continuation time has elapsed. Note that, here, the time for which the processing (steps S106 to S108, described below) is executed is referred to as a “service performance period”. Further, when the processing is terminated when the service continuation time has elapsed, provision of the remote control operation service in accordance with the request of the driver is completed.

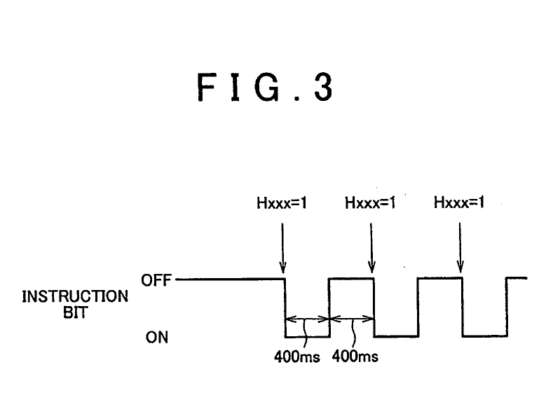

During the service performance period, the control portion 24 confirms whether or not the battery voltage of the battery 34 measured by the voltage measurement portion 22 is equal to or more than 10.5 V (step S106), in a similar manner to step S101. The reason for setting the value 10.5 V is the same as that noted for step S101. Note that, when the battery voltage of the battery 34 is equal to or above 10.5 V, the control portion 24 operates the on-board vehicle device (for example, causes the light 46 to flash) in accordance with the operation control command. In this example, FIG. 3 will be used to explain the operation control that is executed when the light 46 is caused to flash.

With this embodiment, when the control portion 24 causes the light 46 to flash, in order to make the light 46 light once, a lighting instruction bit (Hxxx=1) is transmitted at regular time intervals to the security ECU 40 for each event. Note that, according to this embodiment, the lighting instruction bit is sent with a cycle of 800 ms. A lighting time for each event is set at 400 ms, with the interval therebetween set at 50% of the cycle. Accordingly, as shown by FIG. 3, each time the lighting instruction bit from the command portion 24 is received, the security ECU 40 causes the light 46 to light for 400 ms, and then extinguishes the light 46 for 800 ms×50%, namely, for 400 ms. As a result, the light 46 is lit and extinguished in repetition within a single cycle (800 ms), so as to flash once within the 800 ms cycle. Note that, for example, sounding of the horn 44 can be realized in a similar manner by the control portion 24 transmitting a predetermined horn sounding instruction bit to the security ECU 40 for each event. However, with this embodiment, the light 46 is caused to flash in the above described manner. Thus, in FIG. 3, as shown in step S107 of FIG. 2, when 800 ms has elapsed since the last operation instruction was sent (step S108), the lighting instruction bit for the light 46 is sent to the security ECU 40 for each event, whereby the light 46 is operated, namely, is caused to light (step S108).

On the other hand, when the battery voltage of the battery 34 is less than 10.5 V (step S106), it is not possible to repeatedly flash the light 46 for the same reason as when it was determined that the remote control operation service could not be started. Namely, repeated flashing of the light 46 is not possible since the battery 34 is low. Accordingly, in this case, the control portion 24 terminates performance of the remote control operation service (namely, flashing of the light 46), and provision of the remote control operation service is compulsorily terminated. Note that, the minimization of electric power consumption is prioritized by not sending a message indicating that the remote control operation service has been compulsorily terminated during its performance. Of course, in a similar manner to the case of the previously described service acceptance confirmation, the determination criterion for determining whether the remote control operation service is compulsorily terminated may be changed to a value larger than 10.5 V. If so, the specifications may be changed such that a compulsory termination notification is sent to the driver via the center 2.

According to this embodiment, provision of the remote control operation service (for example, causing the light 46 to flash) in the above described manner allows the driver to find the position of his vehicle, namely, the vehicle 10, within the large parking lot, since the light 46 of the vehicle 10 is flashing.

Further, according to this embodiment, the above described configuration facilitates provision of the remote control operation service. At the same time, however, it is ensured that even if electric power of the battery 34 is consumed in order to provide the remote control operation service, there is sufficient remaining battery capacity to start the engine. Accordingly, problems, such as being unable to start the engine, can be avoided. In particular, if the battery voltage becomes less than 10.5 V during the service performance period, the remote control operation service is compulsorily terminated during its provision. Thus, the driver is able to set the service continuation time without feeling any anxiety, since he does not have to be concerned about the remaining charge of the battery.

As will be apparent from the above description, while the vehicle 10 is parked, it is desirable that electric power consumption of the battery 34 is kept to the minimum possible. Further, if such minimization is achieved, it is possible to continue performance of the remote control operation service for a long time (at a maximum, the set service continuation time) without having to perform compulsory termination thereof.

However, the telematics terminal unit 12 is operated even when the ignition switch 36 is off, and therefore causes the electric power of the battery 34 to be consumed. Note that, in the above explanation, the operation timing of the telematics terminal unit 12 was not discussed in any depth. However, the telematics terminal unit 12 may be placed on constant stand-by for when a request is sent from the center 2. However, if the telematics terminal unit 12 is placed on constant stand-by in this way, the electric power of the battery 34 is rapidly used up by the operation of the telematics terminal unit 12. Thus, in this embodiment, the telematics terminal unit 12 is placed on stand-by for a limited length of time so as to promote reduced consumption of electric power.

The telematics terminal unit 12 according to this embodiment, following turning off of the ignition switch 36 (IG/OFF), the remote control operation service is completely terminated after a predetermined period (y) has elapsed. Note that, the value of the predetermined period (y) can be set as chosen. For example, y may be set as 2 days. The center 2 is able to obtain the value set for each telematics terminal unit 12 (in the vehicles of different registered members of the remote control operation service) by directly receiving the value from each telematics terminal unit 12, or by using a predetermined calculation that utilizes the ID of the telematics terminal unit 12, or the like.

According to this embodiment, it is possible to reduce consumption of electric power while the ignition switch 36 is turned off to as low a level as possible, by limiting the operation time of the telematics terminal unit 12. It goes without saying, however, that while the telematics terminal unit 12 is in the paused state, it is not able to respond to service request from the dirver. Accordingly, it becomes necessary for the telematics terminal unit 12 to operate with a request reservation system.

Note that, with this embodiment, in order to provide the remote control operation service, the operator at the center 2 responds to the driver's request. However, it is not essential to employ an operator to responds to the driver's request. For example, it is possible to respond to the driver's request using a device that includes a voice response system with a speech recognition device, and the like. Moreover, use of a speech recognition device is not essential. For example, provision of the remote control operation service can also be realized by giving voice instructions to the driver about the operation details of the on-board vehicle device, the service start time and the service continuation time. The driver can then follow these voice instructions so as to input the information using a key pad of the mobile phone 4. Further, if the mobile phone 4 has a browser function, a setting screen for setting necessary items such as the details of the operation of the on-board vehicle device may be transmitted to the mobile phone 4. By displaying this setting screen on the display screen of the mobile phone 4, it is possible to input and set any necessary information using the display screen. In this case, the server 6 of the center 2 transfers the service request information transmitted from the mobile phone 4 to the vehicle 10. Accordingly, there is no need to employ an operator.

In addition, the transmission function of the above described setting screen and the receiving function for the service request information transmitted from the mobile phone 4 may be incorporated within the telematics terminal unit 12. By adopting such a configuration, it is possible to facilitate direct information exchange between the mobile phone 4 and the telematics terminal unit 12. Thus, the driver can directly exchange information with the telematics terminal unit 12 without having to go through the center 2. Accordingly, the driver can directly send the remote control operation service request to the telematics terminal unit 12, whereby it is possible to provide the remote control operation service without establishing the center 2.

Further, according to this embodiment, the processing function for the remote control operation service performance control apparatus that provides the remote control operation service in accordance with the service request information is realized by the control portion 24. The control portion 24 determines whether provision of the remote control operation service is possible from within the vehicle 10 based on the state of the battery 34, namely, the remaining charge of the battery 34. However, the processing function for the remote control operation service performance control apparatus may be provided in the server 6 of the center 2. If such a configuration is adopted, the determination as to whether the remote control operation service can be provided may be made by the server 6 based on information related to the state of the battery 34 that is transmitted from the telematics terminal unit 12.

1. A remote control operation service performance control apparatus comprising:
a wireless communication unit that exchanges information with a portable user terminal unit; and
a control unit that performs operation control of an on-board vehicle device in accordance with service request information that is received from the wireless communication unit, wherein
the control unit determines, based on a state of a storage battery unit that supplies electric power to the on-board vehicle device, whether to perform the operation control of the on-board vehicle device in accordance with a service request from the portable user terminal unit.

2. The remote control operation service performance control apparatus according to claim 1, wherein the service request information includes an operation control command that causes the on-board vehicle device to operate.

3. The remote control operation service performance control apparatus according to claim 1, wherein
when the state of the storage battery unit is a predetermined state that indicates a predetermined service rejection condition, the control unit determines that the state of the storage battery unit makes it difficult to perform the operation control of the on-board vehicle device in accordance with the service request from the portable user terminal unit, and transmits a service rejection notification to the portable user terminal unit in response to the service request.

4. The remote control operation service performance control apparatus according to claim 3, wherein the service rejection condition includes a condition that voltage value of the storage battery unit is equal to or lower than predetermined voltage value.

5. The remote control operation service performance control apparatus according to claim 1, wherein when the control unit determines that the state of the storage battery unit during performance of a remote control operation service makes it difficult to perform the operation control of the on-board vehicle device, the control unit compulsorily terminates the remote control operation service that is being performed.

6. The remote control operation service performance control apparatus according to claim 5, wherein the service rejection condition includes a condition that voltage value of the storage battery unit is equal to or lower than predetermined voltage value.

7. A vehicle remote control operation service system comprising:
a center that uses wireless communication to request that the vehicle perform a remote control operation service in accordance with a service request from a portable user terminal unit, the center being at a location that is remote from the vehicle;
a remote control operation service performance control apparatus which is mounted in the vehicle and which includes a wireless communication unit that wirelessly communicates with the center, the remote control operation service performance control apparatus providing the remote control operation service in accordance with service request information that is received from the center;
a control unit which is mounted in the remote control operation service performance control apparatus and which performs operation control of an on-board vehicle device in accordance with the service request information received from the center, and
a service performance control unit that determines, based on a state of a storage battery unit that supplies electric power to the on-board vehicle device, whether the control unit should perform the operation control of the on-board vehicle device in line with the service request from the portable user terminal unit.

8. The vehicle remote control operation service system according to claim 7, wherein the service request information includes an operation control command that causes the on-board vehicle device to operate.

9. The vehicle remote control operation service system according to claim 7, wherein
the service performance control unit is provided at the center and determines whether the control unit should perform the operation control of the on-board vehicle device based on information indicating the state of the storage battery unit, the information being sent via the wireless communication unit from the control unit.

10. The vehicle remote control operation service system according to claim 7, wherein when the state of the storage battery unit is a predetermined state that indicates a predetermined service rejection condition, the service performance control unit determines that the state of the storage battery unit makes it difficult to perform the operation control of the on-board vehicle device in accordance with the service request from the portable user terminal unit, and transmits a service rejection notification to the portable user terminal unit in response to the service request.

11. The vehicle remote control operation service system according to claim 10, wherein the service rejection condition includes a condition that voltage value of the storage battery unit is equal to or lower than predetermined voltage value.

12. The vehicle remote control operation service system according to claim 7, wherein when the state of the storage battery unit becomes a predetermined state that indicates a predetermined service rejection condition during performance of the remote control operation service, the service performance control unit determines that the state of the storage battery unit makes it difficult to perform the operation control of the on-board vehicle device in line with the service request from the portable user terminal unit, and compulsorily terminates the remote control operation service that is being performed by stopping the operation control of the on-board vehicle device performed by the control unit.

13. The vehicle remote control operation service system according to claim 12, wherein the service rejection condition includes a condition that voltage value of the storage battery unit is equal to or lower than predetermined voltage value.

14. A remote control operation service provision method for providing a remote control operation service for a vehicle having a wireless communication unit by performing operation control of an on-board vehicle device in accordance with a service request from a portable user terminal unit, comprising:
a step of detecting a state of a storage battery unit that supplies electric power to the on-board vehicle device, the detecting step being performed when the wireless communication unit receives the service request from the portable user terminal unit; and
a step of determining whether to perform the operation control of the on-board vehicle device in accordance with the service request from the portable user terminal unit based on the detected state of the storage battery unit.

15. The remote control operation service provision method according to claim 14, wherein the service request information includes an operation control command that causes the on-board vehicle device to operate.

16. The remote control operation service provision method according to claim 14, further comprising a step of notifying the portable user terminal unit that provision of the remote control operation service is rejected when the determining step determines that it is difficult to perform the operation control of the on-board vehicle device based on the fact that the state of the storage battery unit is a predetermined state that indicates a predetermined service rejection condition.

17. The remote control operation service provision method according to claim 16, wherein the service rejection condition includes a condition that voltage value of the storage battery unit is equal to or lower than predetermined voltage value.

18. The remote control operation service provision method according to claim 8, further comprising:
a during-service detection step that periodically detects the state of the storage battery unit during provision of the remote control operation service; and
a termination step that, when the during-service detection steps detects that the state of the storage battery unit is a predetermined state that indicates a predetermined service rejection condition, compulsorily terminates the remote control operation service that is being provided.

19. The remote control operation service provision method according to claim 18, wherein the service rejection condition includes a condition that voltage value of the storage battery unit is equal to or lower than predetermined voltage value.
